(19) United States
(12) Patent Application Publication
(10) Pub. No.: US 2007/0153910 A1
(43) Pub. Date: Jul. 5, 2007

(54) System and method for delivery of content to mobile devices

(76) Inventor: David Levett, Bisley (GB)

Correspondence Address: MORRISON & FOERSTER, LLP, 555 WEST FIFTH STREET, SUITE 3500, LOS ANGELES, CA, 90013-1024, US

(21) Appl. No.: 11/639,513

(22) Filed: Dec. 15, 2006

(30) Foreign Application Priority Data
Dec. 15, 2005 (GB) 0525527.8

(51) Int. Cl. H04N 7/16; H04N 11/02; H04N 7/12; H04B 1/66; H04N 11/04; H04N 5/00

(52) U.S. Cl. 375/240.25; 725/62; 348/608; 375/240.26; 348/384.1

(57) ABSTRACT

The preferred embodiments of the present invention relates to the preparation and delivery of media content from a source to a remote device, and the use of the remote device to re-construct, format, composite, convert and/or otherwise pre-process the content into a suitable form for presentation/playback. In particular it relates to audio and/or visual content that may be delivered in a piecemeal, disjoint, complex and/or highly compressed form to a remote mobile device such as a mobile phone where such a device may not have the capability to adequately present the content in its delivered form without further pre-processing due to insufficient on-board processing power or format incompatibilities. The present invention also allows for media content to be reconstituted for presentation in a variety of ways without the need to re-deliver the entire content each time.

### BACKGROUND

1. Field of Invention

The present invention relates to method and system for formatting and delivering media content to mobile devices, such as mobile cell phones, and for preparing the delivered content for playback on the delivered devices.

2. Description of Related Art

Conventional methods of content delivery to a remote device typically rely on the content being prepared at source in a form suitable for presentation on the remote device. The approach of pre-prepared content at source is used, inter alia, for audio and video files (or otherwise media data streams) that are traditionally compressed and encoded prior to delivery in a form suitable for “on-the-fly” decoding, decompression and playback on the intended remote device. An example of such a conventional delivery method is the 3GPP format commonly used today for video delivery to mobile phones.

In some instance, adjustments must be made to the delivered content prior to, or during, presentation such as:
(a) where the content is encrypted at source, it is decrypted and on occasion verified by the device either on receipt or immediately prior to presentation on the remote device to ensure its integrity or to protect the content from piracy through a variety of Digital Rights Management (‘DRM’) approaches;
(b) where the content is enhanced in some fashion on the remote device during presentation. (e.g. CD players that perform ‘oversampling’ to improve low-pass filter response; psychoacoustic processing to simulate 3D surround sound from stereo audio content; brightness and contrast adjustments of video playback);
(c) where the content is edited in a manually assisted fashion on the device (e.g. in audio music synthesis; basic video editing; image manipulation); and/or
(d) where the content is composed/reformatted on the remote device for delivery to another device (e.g. multimedia messaging ‘MMS’).

Each of the above instances relies on the delivery of presentable content from the source or locally captured by the device (e.g. video capture from an on-board camera). This means that the type of content that can be presented is often limited by the capabilities of the device.

As an example, if (as is the case for most mobile phones) the processing power of the remote device is insufficient to handle relatively complex compression algorithms on-the-fly (i.e., in real time), the content must be prepared at source in a less complex form, usually resulting in lower quality presentation results and higher data delivery costs. Playback of state of the art ‘high quality at high compression’ algorithms such as the ‘High Complexity’ modes of today's H264 and AAC standards are beyond the capabilities of most mobile devices, even those that are dedicated to audio and/or video playback. What is desired is a means to gain the benefits of the best compression algorithms available at the time, while at the same time enabling such prepared content to be presented on low-powered devices.

A further disadvantage of conventional approaches that require a consistent content format for playback is that the source material may differ in its consistency and could benefit from a variety of encoding techniques applied as appropriate. For example, it is known that JPEG algorithms are an effective means for compressing photographic images with many varying tones, but that GIF algorithms are more effective for compressing simple computer graphics. In video compression, fast moving action segments demand higher frame rates than still segments. It is known that there are solutions that attempt to adjust to the varying consistency of the content such as ‘Variable Bit Rate’ (VBR) compression, but these methods necessarily increase the processing demands on the presentation/playback device and can lead to presentation/playback errors, such as audio distortion and dropped frames as the remote device struggles to keep up. What is desired is a means to allow the best techniques to be applied at source for each segment of the content while delivering it in a sufficiently simple form that a remote device can present it effectively within its limitations.

In some cases, it is also desirable to modify content already on a remote device with marginal updates without the need to re-deliver the entire content. For example, a video trailer for a soon to be released blockbuster movie could be updated with headlines such as ‘Coming Soon!’, ‘Less than a week away!’, ‘Opens Tomorrow’ and ‘Now Showing . . . ’. Alternatively, segments of the trailer could be changed (or alternative segments displayed) each time the trailer is viewed. The content could be further enhanced on the remote device to add the recipient's name, town or even directions to the local cinema.

Also to be considered is the case where a user of a remote device wishes to customize some content in such a way that their contribution is delivered to another remote device either directly, through a central server, or a combination of both. For example, the user may wish to send a video greeting card to another remote device where the main content of the video is downloaded form a central source and the custom content (e.g. the greeting message) sent via local transfer (e.g. Bluetooth between phones). It is desirable to enable the combination or composition on a remote device of content from various sources into a single seamless content stream for presentation.

It is important to consider that a majority of mobile devices are insufficiently powerful to present content prepared with state of the art methods. Taking mobile phones as an example, only the most sophisticated and hence most expensive models are able to play video files compressed with advanced algorithms. What is desired is a method and system for allowing sophisticated video files to be delivered and presented effectively on lower powered and hence lower cost phones, thus appealing to a much wider population.

Mobile devices are many and various and each has its own construction and limitations. In a scenario were some content is to be delivered for presentation to a multitude of disparate devices it is a disadvantage to require that the content be delivered in a uniquely appropriate format for each device. It is known that there are so called ‘standards’ for content presentation on mobile devices. However it is often that case that due to physical or design limitations each type of device may present this standard content to varying degrees of effectiveness. For example, video decoding and decompression may be performed in dedicated hardware on some mobile devices while others rely on software that executes on the core processor of the device. In the first case, the dedicated hardware is limited to interpreting the ‘standards’ according to the state of the ‘standards’ at the time the dedicated hardware was designed. Software solutions are more flexible and can be upgraded if necessary as the ‘standards’ evolve, but may suffer other disadvantages such as interruptions in processor availability when the core processor is called upon to service interruptions from other features of the device. What is desired is a method for delivering identical content to multiple devices independent of their construction and allow each device to pre-process it into the most appropriate form for effective presentation on that device taking into account its limitations.

The present invention aims to deliver each of the desired objectives identified above by leveraging the latent processing power of the remote device when in an idle state. Although relatively low powered compared to desktop computers and servers, most remote devices spend the vast majority of their time idle. By harvesting this ‘spare’ capacity, the invention is able to pre-process the variety of content into a single simple content file that can be presented effectively within the limits of the device.

### SUMMARY OF THE PRESENT INVENTION

The present invention is predicated on the counter-intuitive insight that the format of content delivered to a remote device does not necessarily need to be compatible with the format necessary for effective presentation on that remote device. Instead, in accordance with a preferred embodiment of delivery, the original content can be prepared in a format that is optimal for delivery to a single or a multitude of remote devices and each remote device can pre-process the content into a compatible form suitable for effective presentation.

The term ‘content’ used in this specification means self-contained audio and/or visual or related information such as music, speech, video, images, text, animations and graphics that is intended for presentation on a remote device.

The term ‘presentation’ used in this specification means the automatic or on-demand playback of content through the output functions of the device such as speakers and/or visual display.

The term ‘effective presentation’ used in this specification means the optimal or near optimal presentation of content on a remote device as if it had been carefully prepared at source specifically for that device regardless of delivery or storage costs.

In accordance with a preferred embodiment of the present invention, there is a method for preparing original content for delivery to a remote device where one or more preparation techniques are chosen appropriately according to the consistency of the content. These techniques may include amongst others: segmentation, filtering, compression, encoding, encryption and digital rights management.

In a second aspect, there is a method for determining which of manually or automatically preparation technique is appropriate for some or each segment of the original content.

In a third aspect, there is an apparatus that can be programmed to prepare original content according to a variety of preparation techniques.

In a fourth aspect, there is a plurality of the preparation techniques that have been applied to each segment of the content that is subsequently delivered to a remote device such that the content can be interpreted by an apparatus on the remote device.

In a fifth aspect, there are one or more data files containing the prepared content in a form for delivery to a remote device.

In a sixth aspect, there is an apparatus for delivering the prepared content to one or a multitude of devices. This generally takes the form or a wired or wireless network and associated transmission apparatus along with a method for identifying and communicating the content to one or more remote devices.

In a seventh aspect, there is a remote device that is capable of receiving prepared content from some source via some delivery apparatus, have the capacity to operate a compositing and conversion apparatus and the ability to present content in some form through its output functions. In accordance with the preferred embodiment, this could equally be a multitude of remote devices, each with the capabilities described above.

In an eighth aspect, there is a configuration specification provided that determines what content or content subsets available on the remote device are to be combined and what format conversion is necessary in order to produce an instance of pre-processed content in a form suitable for effective presentation on the remote device.

In a ninth aspect, there is a method for pre-processing by decrypting, decompressing, compositing, generating, recompressing and/or otherwise converting one or more items of prepared content on a remote device according to a configuration specification.

In a tenth aspect, there is an apparatus or a machine-readable medium containing software instructions that operates on the remote device and that can be programmed to composite and/or convert one or more items of prepared content into a form suitable for presentation on that device.

### BRIEF DESCRIPTION OF THE DRAWINGS

FIG. 1 is a schematic illustration of a system for delivery of content to mobile devices in accordance with a preferred embodiment of the present invention;

FIG. 2 is a schematic illustration of a system for delivery of content to mobile devices in accordance with an alternative embodiment of the present invention;

FIG. 3 is a graphical illustration of a method for recombining segments of a media content in accordance with an alternative embodiment of the present invention;

FIG. 4 is a schematic illustration of a system for delivery of content to mobile devices in accordance with another alternative embodiment of the present invention;

FIG. 5 is a schematic illustration of a method of compressing media content in accordance with an alternative embodiment of the invention; and

FIG. 6 is another schematic illustration of the method illustrated in FIG. 5.

### DETAILED DESCRIPTION OF PREFERRED EMBODIMENTS

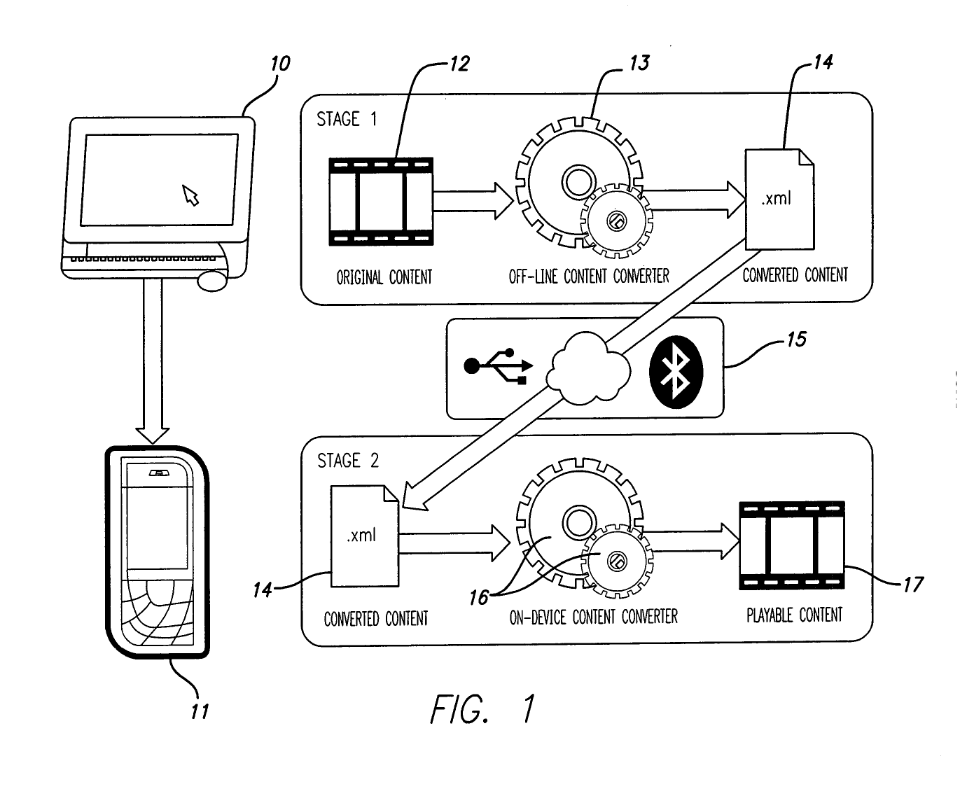

The present invention will be described with reference to FIGS. 1-6.

The preferred embodiment of the present invention will be hereinafter described with reference to an implementation called the ‘Video Encoding System’. The Video Encoding System provides the preparation, delivery, pre-processing and presentation functionality described in the preceding sections. As discussed in the Background section, the conventional approach for content delivery to mobile devices involves preparing content in accordance with the presentation capabilities of the targeted remote device(s), regardless of whether this is the most efficient approach to preparing content for a given delivery size or quality. The present invention overcomes this disadvantage by allowing the content to be prepared optimally even if the resulting form is initially unsuitable for presentation on the remote device. In accordance with the preferred embodiments, after the content is delivered to the remote device, the content may then be combined with other content already on the device, restructured or otherwise composited and then converted to a form that is suitable for effective presentation on the device.

In accordance with the preferred embodiment, the pre-processing stage is preferably performed sometime prior to the presentation event such that it does not require use of the limited processing capabilities of the remote device during the presentation stage. In this manner, complex pre-processing may be performed on the delivered content that might take minutes or even hours on a low-powered processor producing simplified content in a form that can be presented effectively.

FIG. 1 is a schematic representation of the basic approach in accordance with the preferred embodiment. As shown in FIG. 1, Stage 1 operates on a server 10 that is independent of the remote device 11 and performs the preparation of the original or source content 12. In the Video Encoding System, the original content 12 (i.e., source content) is initially provided in the form of high resolution video files such as TV quality advertising video clips (e.g., NTSC or ATSC encoded video signals). The original content is then converted into a form suitable for delivery to a remote device, typically a mobile phone.

In the case of simple content conversion, the offline content conversion 13 takes the form of a video compression process using the best available compression algorithms for creating highly compact high quality video of suitable dimensions for playback on the remote device. In accordance with one embodiment, a high complexity H264 algorithm is used to convert broadcast quality digitally encoded Betacam, PAL and NTSC format digital video files into QCIF (176×144 pixels) size or similar at 25 frames a second. The output dimensions and frame rates are chosen such that they are the maximum parameters for the range of remote devices to which the content is to be delivered. The means for effecting the conversion could be either a dedicated video converter or simply a programmed processor for effecting various different compression algorithms.

Once the original content is prepared, it is preferably appended, or “tagged,” with information about the particular conversion process used so that the remote device receiving the converted content can determine how to interpret the delivered content for pre-processing. The converted content 14 is then delivered (e.g., broadcast, multicast, or unicast) via any one or combination of a variety of transmission means 15 (e.g. Cellular Wireless ‘GPRS’, Wired ‘USB’, or Wireless ‘Bluetooth’) to one or more remote devices. Once the prepared content 14 is delivered to the remote device 11, it is stored in a content archive ready for pre-processing.

In accordance with the preferred embodiment, prior to presenting the received content on the device, a process is first run through an on-device content converter 16 (which may be a dedicated processor or a programmed general processor) to convert the desired archived content into a playable content 17 in a video format that can be played on the remote device. The chosen presentation format is typically a low complexity H264 format for higher end mobile phones and 3GPP format for middle range phones that are capable of playing video. Due to the simplified nature of these formats, the output of the pre-processing stage typically results in video files that a substantially greater in size than that of the delivered content for the same quality video.

In typical results, a 30 second video processed using the Video Encoding System can be prepared to a size as small as 150 Kbytes using a variety of filtering and compression techniques. After delivery and pre-processing on the remote device the resulting video file in a form for effective presentation is typically around 1.5 Mbytes, a tenfold increase in size. Since transmission over cellular wireless networks using GPRS is typically charged according to the bandwidth consumed, a tenfold reduction in delivery size equates directly to a tenfold reduction in transmission costs, making it cost effective for example to deliver video advertising to mobile phones. Due to its simplified form, the converted larger video content now requires less decompression and decoding processing during playback, making it more presentable on a mobile device that may not otherwise have had sufficient processing power to simultaneously decompress and playback the original content.

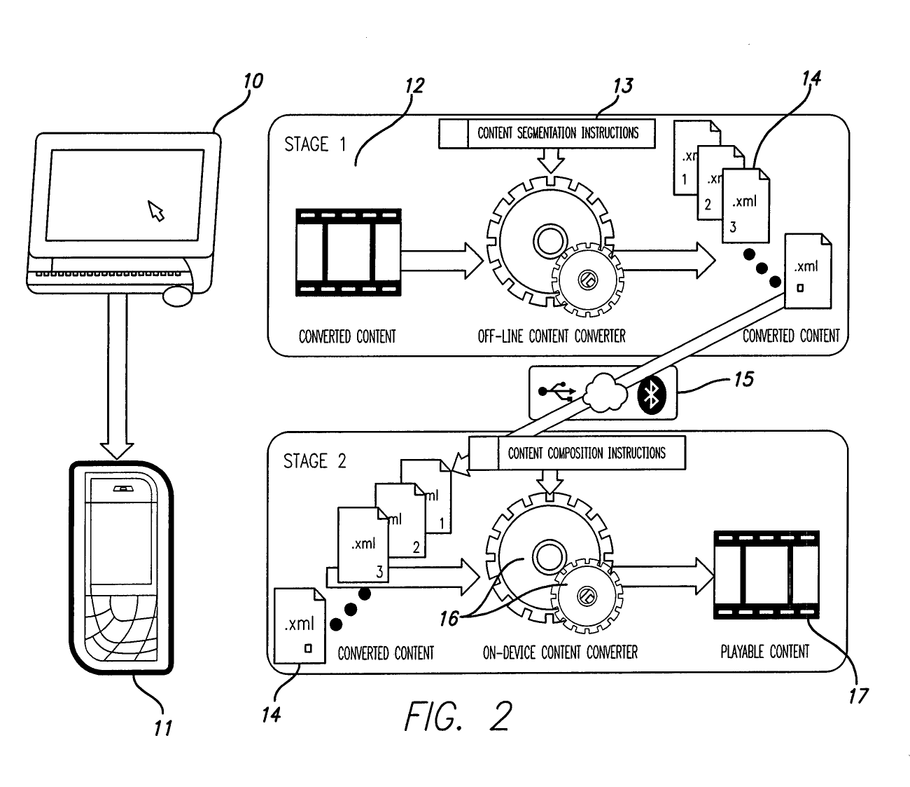

FIG. 2 illustrates an alternative embodiment of the present invention whereby the original content 12 is segmented in a suitable fashion. Specifically, each segment of the original content is separately prepared and delivered to the remote device either independently or in aggregated but still segmented form. Once the entire segmented content has been received by the remote device along with instructions on how the content is to be composited and converted, the pre-processing stage can be programmed to select appropriate segments for a given presentation and output to a coherent single video file for later presentation.

One advantage of this segmentation approach is that each segment could potentially be prepared/formatted using a different method, the particular method being selected in accordance with the nature of the segment. For example, a fast moving action segment might be encoded at a higher frame rate than slow moving or still image segments without noticeable loss of presentation quality. The pre-processing step of the system can then convert the various formatted segments (e.g., different frame rates) to the highest possible frame rate available for effective presentation on the device. By providing the ability to format different segment with different methods of compression, this embodiment increases the content provider's ability to maximize bandwidth efficiency and/or optimal content presentation.

Although conventional methods of content delivery, such as Variable Bit Rate encoding, attempt to adapt to the complexity of the content in the video frame sequences being compressed, they are necessarily limited as to the extent of the adaptation possible. Using the approach in the present invention, it is possible to use a different compression technique for each segment, for example simple computer graphics or cartoon animation might be compressed more appropriately using a different algorithm from that used for photographic video segments. This is analogous to the appropriate use of GIF and JPEG formats for still images where the former is more appropriate for low colour palette graphical images and the latter more effective for photo-realistic images.

A further advantage of this alternative embodiment of segmentation approach is that it allows a piece of content to be delivered to a remote device in a form that can be reconfigured for further presentations. For instance, in the case of a video advertisement clip that is to be played on more than one occasion (e.g., once a day for three days), each segment may be modified in some way according to some criteria such as a predetermined configuration schedule, or even the individual preferences and profile of the remote device owner.

In another example, the content provider (or advertiser) may deliver to remote devices a video clip such as a movie trailer advertisement with different opening sequence segments (e.g., “Coming soon to a theatre near you,” or “In theatres tomorrow); in such an example, when the video clip is played for the first time, when the movie is one week from being publicly released in the theatres, the opening sequence segment of “Coming soon to a theatre near you” can be first presented before replaying the rest of the movie trailer. Upon a subsequent presentation of the advertisement, say the day before the movie is to be publicly released, the opening segment of “In theatres tomorrow” can be used instead. This results in a powerful and flexible way to deliver content that might be displayed differently on each device without having to uniquely prepare the content for each device. If the content is viewed more than once in different forms, the reused segments are already on the remote device, further saving delivery transmission costs.

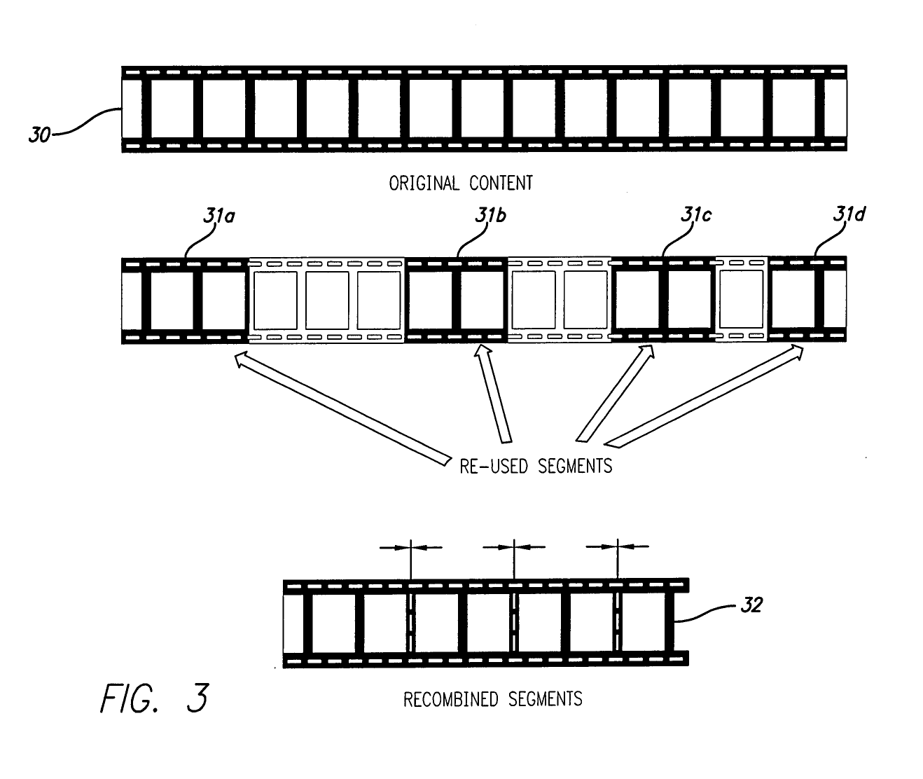

FIG. 3 is an illustration of one way in which a segmented content sequence 30 can be combined to produce a unique presentation. As shown in FIG. 3, reusable segments 31a, 31b, 31c, and 31d are selectively recombined in order to produce a second viewable video clip 32. For instance, a video clip commercial, when presented for the first time, may be 30 seconds long. Upon second presentation, the advertiser may wish to present a 15 second version of the original commercial so as to minimize the intrusion to the user of the mobile device while still accomplishing the objective of reminding the user of the advertised product or service. The ability to shuffle segments allows the content provider/advertiser more versatility to provide different advertisement presentation.

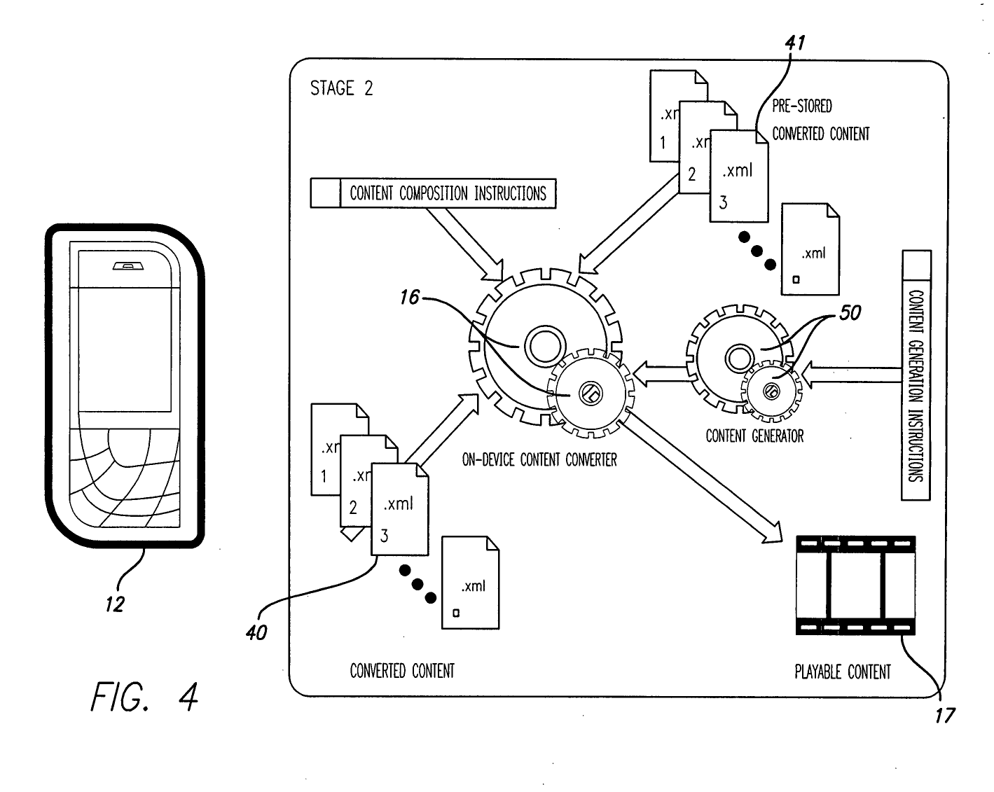

FIG. 4 illustrates is yet another alternative embodiment of the present invention. Specifically, FIG. 4 schematically illustrates an improved system from FIG. 2 whereby the remote device 12 combines segments of delivered content 40 with segments of content 41 that is already archived on the remote device. In this manner, new and unique content can be pre-processed for presentation, by delivering only the marginal changes to content known to be already archived on the device. As before, the reuse of existing archived segments on the device results in a reduction of delivery transmission costs (it is noted that, in FIG. 4 only the remote device pre-processing stage is illustrated as the preparation stage is similar to what is shown in FIG. 2).

In accordance with another embodiment, the pre-processing phase of the system allows for content to be generated programmatically via a content generator 50 (which may be, inter alia, a specific processor or a programmed general processor) and combined with delivered and pre-stored segments as before. Examples of such generated content may include graphical charts, image slide shows, video filtering of segments and computer generated vector and 3D animation. In each of these cases, the instructions for generating the content along with any necessary static images are preferably significantly smaller in delivery size than had they been delivered as high quality video segments. Furthermore, computer generated graphics often require a high level of presentation detail to ensure that they can be presented effectively. For example, text generated on the device and subsequently encoded into a video for presentation is likely to be of higher quality than had they been subject to high compression during the preparation phase.

In accordance with the yet another embodiment of the present invention, high quality textual annotation of a video sequence that may be uniquely provided for each unique mobile device receiving the video sequence. Specifically, it may be desirable to display unique information associated with the device (such as the name of the owner of the device, or some time dependent text within the video). In another example, an advertisement for a movie that includes a trailer may be adapted for presentation to include the number of days remaining until the movie opens at the local cinema. Each time the advertisement is presented it will appear to have been uniquely prepared for that moment.

In this particular example, in contrast the segmentation example discussed above wherein different opening sequences are used, text annotations may instead be used to achieve the same objective. Another advantage of using textual annotation is that it can be performed in the native speaking language of the owner of the remote device, allowing a single piece of content to be delivered to devices of different demographic communities, each customized on the device into their own language.

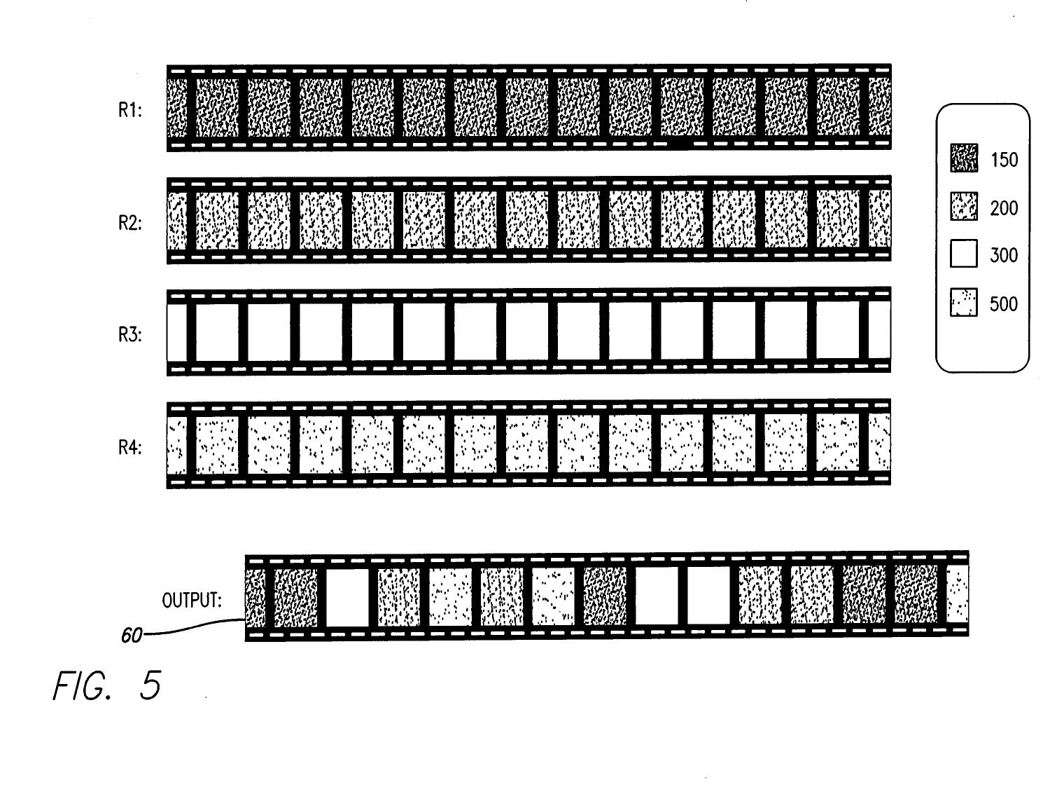

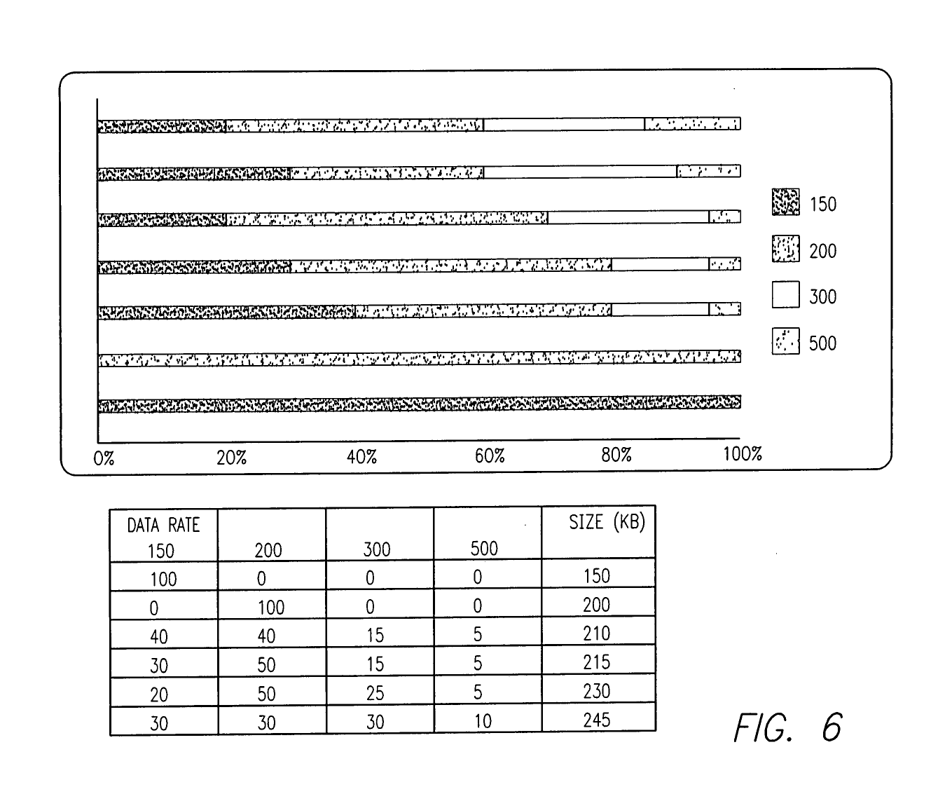

FIGS. 5 and 6 further illustrate the process and benefits of the segmentation method illustrated in FIG. 2 whereby an image is segmented by some means prior to preparation and with the appropriate maximum level of compression that delivers adequate high quality results is performed for each segment.

Specifically, as it is illustrated in FIG. 5, an entire original content is compressed at each of four compression levels labelled R1 to R4 (150 KB, 200 KB, 300 KB and 500 KB respectively). The output content 60 may be comprised of segments selectively combined from the various compressed content. FIG. 6 illustrates the resulting expected encoding size and showing that, in this particular instance, one can achieve a final compressed size of under 250 Kbytes for a 32 second video clip, even though 40% of the video is encoded at a higher rate. In the example described here, the segmentation is performed by a combination of automatic and manual means to ensure a sufficient high quality of the resulting presentation on the remote device.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself. The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements. The claims are thus to be understood to include what is specifically illustrated and described above, what is conceptionally equivalent, what can be obviously substituted and also what essentially incorporates the essential idea of the invention.

What I claim:

1. A method for delivering content to a remote device, said method comprising the steps of:
compressing a media data file in accordance with a selected compression method;
appending, to the compressed media data file, compressing information, said compressing information indicating the method of compression used to compress the media data file; and
transmitting the appended compressed media data file to a remote device;

2. The method of claim 1, further comprising the steps of:
compressing a second media data file in accordance with another selected compression method, said another selected compression method being different than the selected compression method;
appending, to the compressed second media data file, second compressing information, said second compressing information indicating the method of compression used to compress the second media data file;
combining the compressed media data file and the compressed second media data file;
transmitting the combined media data file to a remote device.

3. The method of claim 1 or 2, wherein said step of transmitting is one of broadcast, multicast, or unicast.

4. The method of claims 1 or 2, wherein said media data file is a video data file.

5. A method of presenting media data file on a remote device, said method comprising the steps of:
receiving compressed media data file;
extrapolating, from said compressed media data file, compression information, said compression information indicating a compression method by which the media data file was compressed;
determining a decompression method in accordance with the compression information;
before presenting the media data file on the remote device, decompressing the compressed media data file in accordance with the determined decompression method; and
presenting the decompressed media data file on the remote device.

6. The method of claim 5, wherein said media data file is one of a video file, computer generated graphics file, and audio file.

7. A method for presenting a composite media data file on a mobile device, said method comprising the steps of:
receiving a plurality of media data files;
extrapolating, from each of said plurality of media data files, corresponding compression information indicating a method by which each of said plurality of media data files is compressed;
using the extrapolated compression information for each media data file to determine a decompression method for each media data file;
decompressing each of said plurality of media data files;
selectively combining the decompressed media data files into a composite media data file; and
presenting on the mobile device the composite media data file.

8. The method of claim 7, wherein each media data file is one of a video data file, audio data file, graphics file, and text file.

9. The method of claim 7, further comprising the steps of:
disassembling the composite media data file into a plurality of disassembled media data files;
selectively combine a subset of said plurality of disassembled media data files into a second composite media file; and
presenting said second composite media file.

10. A remote device for receiving and presenting media data files, said remote device comprising:
a receiver for receiving a plurality of media data files;
a programmed processor for extrapolating, from each of said plurality of media data files, corresponding compression information indicating a method by which each of said plurality of media data files is compressed, and using the extrapolated compression information for each media data file to determine a decompression method for each media data file;
a decompressor for decompressing each of said plurality of media data files;
an assembler for selectively combine the decompressed media data files into a composite media data file; and
a multimedia presenting device for presenting the composite media data file.

11. A remote device for receiving and presenting media data files, said remote device comprising:
a receiver for receiving a plurality of media data files;
a programmed processor for extrapolating, from each of said plurality of media data files, corresponding compression information indicating a method by which each of said plurality of media data files is compressed, and using the extrapolated compression information for each media data file to determine a decompression method for each media data file;
a decompressor for decompressing each of said plurality of media data files;
an assembler for selectively combining the decompressed media data files into a composite media data file; and
a multimedia presenter for presenting on the mobile device the composite media data file.

12. The remote device of claim 11, further comprising:
a disassembler for disassembling the composite media data file into a plurality of disassembled media data files; and
a recombiner for selectively combine a subset of said plurality of disassembled media data files into a second composite media file.

13. A machine-readable medium containing a set of executable instructions for causing a processor of a remote device to perform a method of presenting media data file on a remote device, said method comprising the steps of:
receiving compressed media data file;
extrapolating, from said compressed media data file, compression information, said compression information indicating a compression method by which the media data file was compressed;
determining a decompression method in accordance with the compression information;
before presenting the media data file on the remote device, decompressing the compressed media data file in accordance with the determined decompression method; and
presenting the decompressed media data file on the remote device.

14. A machine-readable medium containing a set of executable instructions for causing a processor of a remote device to perform a method of presenting a composite media data file on a mobile device, said method comprising the steps of:
receiving a plurality of media data files;
extrapolating, from each of said plurality of media data files, corresponding compression information indicating a method by which each of said plurality of media data files is compressed;
using the extrapolated compression information for each media data file to determine a decompression method for each media data file;
decompressing each of said plurality of media data files;
selectively combining the decompressed media data files into a composite media data file; and
presenting on the mobile device the composite media data file.

15. A method for delivering and presenting multimedia content to a plurality of mobile communication device, said method comprising the steps of:
compressing a media data file at the central server;
appending into the compressed media data file compression information, said compression information indicating a method by which the media data file is compressed; and
transmitting the appended compressed media file to the plurality of mobile communication devices, wherein each of said mobile communication devices have different multimedia presentation capabilities,
wherein each mobile communication device, upon receiving the transmitted media data file, extrapolates the compression information and, using the compression information, determines a corresponding method of decompression suitable for decompressing the received media data file into a suitable presentation format for that particular mobile communication device.

16. A system for presenting multimedia data files on a plurality of mobile communication devices, said system comprising:
a central server for compressing and transmitting a multimedia data file to a plurality of mobile communication devices, wherein said central server appends, to the multimedia data file, compression information indicating a method by which the multimedia data file is compressed;
a plurality of mobile communication devices for displaying multimedia data files, wherein each of said plurality of mobile communication devices presents multimedia data files in accordance with the unique capabilities of the device, wherein each mobile communication device, upon receiving the transmitted media data file, extrapolates the compression information and, using the compression information, determines a corresponding method of decompression suitable for decompressing the received media data file into a suitable presentation format for that particular mobile communication device.

17. A method for composing a compressed multimedia data file, said method comprising the steps of:
identifying, from within an original multimedia data file, a plurality of segments of data files for compression in accordance with a first method of compression;
identifying, from within the original multimedia data file, a second plurality of segments of data files for compression in accordance with a second method of compression; and
combining the data files compressed in accordance with the first and the second method of compression.

18. The method of claim 17, wherein said first and second method of compression are selectively chosen in accordance with a predetermined bandwidth allocation.

19. The method of claim 17, wherein said plurality of segments of data files are video files, and wherein said second plurality of segments of data files are audio files.

20. The method of claim 17, wherein said plurality of segments of data files and said second plurality of segments of data files are both video files, and wherein said plurality of segments of data files and said second plurality of segments of data files are identified in accordance with the video content of the data files.
